(19) United States
(12) Patent Application Publication
(10) Pub. No.: US 2011/0180470 A1
(43) Pub. Date: Jul. 28, 2011

(54) AQUEOUS IRON REMOVAL PROCESS AND APPARATUS

(76) Inventor: James Jeffrey HARRIS, Cameron Park, CA (US)

(21) Appl. No.: 13/015,083

(22) Filed: Jan. 27, 2011

Related U.S. Application Data
(60) Provisional application No. 61/298,762, filed on Jan. 27, 2010.

(51) Int. Cl. C02F 1/64; C02F 1/52; C02F 1/56

(52) U.S. Cl. 210/199; 210/198.1; 210/209; 210/205

(57) ABSTRACT

A process and associated apparatus to reduce both ferrous (Fe⁺⁺) iron and ferric (Fe⁺⁺⁺) iron from an aqueous solution. A pH swing process is described in which a phosphoric acid solution is first added and then a base chemical is added. The combination results in generation and precipitation of iron phosphate. The method and apparatus affords flocculent enhanced settling and removal of the iron precipitates and process suitable buffering of the resulting reduced iron aqueous solution.

### CROSS-REFERENCE TO RELATED APPLICATIONS

The application for patent claims priority to U.S. Provisional Application Ser. No. 61/298,762, filed Jan. 27, 2010 and is entitled “An Aqueous Iron Removal Process and Apparatus, which is hereby incorporated by reference herein to the extent permitted by law.

### BACKGROUND OF THE INVENTION

Iron contamination of water is a prevalent industrial water problem. The problem is especially burdensome with waters not exposed to oxygen such as water and brine sourced from deep aquifers, oil and gas production operations, mine drainage and similar scenarios. In such oxygen deprived waters, the ferrous (Fe⁺) form of dissolved iron is present and there is a potential for ferric (Fe⁺⁺⁺) iron formation resulting from eventual exposure to oxygen. Ferrous (Fe⁺⁺) iron is present as a solute in solution while ferric (Fe⁺⁺⁺) iron is present as precipitated, suspended solids ranging in size from nano-size colloidal particles to macro-sized flakes. The ferric (Fe⁺⁺⁺) iron is recognizable as a discoloration and solids deposition in the aqueous solution. The ferrous (Fe⁺⁺) form on the other hand is a solute in complete solution and generally is not apparent and troublesome until sufficient aeration/oxygen contact has occurred, wherein the ferrous (Fe⁺⁺) iron oxidizes into ferric (Fe⁺⁺⁺) iron, discolors the aqueous solution and precipitates as an offending solid.

In one embodiment, the invention addresses the need for the removal of ferrous (Fe⁺⁺) iron and ferric (Fe⁺⁺⁺) iron from brines associated with oil and gas production. Plugging of wells, pipelines, tanks, heat exchangers and other process equipment is a prevalent and serious problem associated with ferric (Fe⁺⁺⁺) iron deposition and ferrous (Fe⁺⁺) iron oxidation, precipitation and deposition.

There are numerous filtration appliances, ion exchange media and oxidation processes available in the prior art to remove the offending irons but these methods are hindered by troublesome fouling and plugging with ferric (Fe⁺⁺⁺) iron and poor removal efficiency of the ferrous (Fe⁺⁺) iron. The prior art is further burdened by solid media expense, consumption and disposal with the corresponding environmental liability. Further, the prior art is substantially hindered when applied to oil and gas production brine because the oils and lighter hydrocarbons normally present in the brine seriously contaminates, fouls and blinds the appliances, media and processes of the prior art. The following US patents provide examples of the prior art: U.S. Pat. No. 7,481,929 (Wilkins et al.), U.S. Pat. No. 7,399,416 (Moller et al.), U.S. Pat. No. 6,555,151 (Hu et al.), U.S. Pat. No. 6,521,810 (Shapiro et al.), U.S. Pat. No. 6,440,300 (Randall et al.), U.S. Pat. No. 6,177,015 (Blakey et al.), U.S. Pat. No. 6,113,779 (Snee), U.S. Pat. No. 5,948,264 (Dreisinger et al.), U.S. Pat. No. 5,919,373 (Naaktgeboren) and U.S. Pat. No. 5,910,253 (Fuerstenau et al.)

The foregoing discussion focuses on efforts of the prior-art to provide effective means to eliminate ferrous (Fe⁺⁺) iron and ferric (Fe⁺⁺⁺) iron from aqueous solutions, particularly in cases where the aqueous solutions are the brines associated with oil and gas production. The prior-art fails to address the elimination of these iron materials in an efficient manner. The prior art further demonstrates many other disadvantages due to unreliability, expense and environmental liability associated with disposal.

Those skilled in the art will clearly recognize the substantial benefits as well as the unique and distinctively superior capabilities afforded by the invention; presenting a cost effective, practical, reliable and environmentally friendly means for removing ferrous (Fe⁺⁺) iron and ferric (Fe⁺⁺⁺) iron from aqueous solutions.

### SUMMARY OF THE INVENTION

In certain embodiments, the present invention provides a simple chemical and pH controlled method for precipitating both ferrous (Fe⁺⁺) iron and ferric (Fe⁺⁺⁺) iron from aqueous solutions; facilitating minimal residual total iron content. A process is provided wherein a ferrous (Fe⁺⁺) iron and/or ferric (Fe⁺⁺⁺) iron entrained aqueous solution is reduced in pH with phosphoric acid to react entrained iron into soluble iron phosphate. The aqueous mixture pH is then elevated with a base chemical to a pH level rendering the iron phosphate insoluble, affording precipitation of the iron phosphate. The elevated pH aqueous solution is separated from the iron phosphate precipitate and the aqueous solution is then buffered as necessary to a suitable pH for process use.

The foregoing has outlined rather broadly certain features and technical advantages of the present invention in order that the detailed description of the invention that follows may be better understood. Additional features and advantages of the invention will be described hereinafter, which form the subject of the claims of the invention. It should be appreciated by those skilled in the art that the concepts and specific embodiments disclosed herein may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE SEVERAL VIEWS OF THE DRAWINGS

Further features of the present invention will become apparent to those skilled in the art to which the present invention relates from reading the following description with reference to the accompanying drawings, in which:

FIG. 1 is a process diagram showing certain embodiments of the invention;

FIG. 2 is a process diagram of an abbreviated embodiment of the invention;

FIG. 3 is a process diagram of an embodiment employing tankage for mixing; and

FIG. 4 is a process diagram of a preferred embodiment of the invention.

### DETAILED DESCRIPTION OF THE INVENTION

This invention relates to a chemical process wherein an iron entrained aqueous solution (brine) is treated with phosphoric acid to decrease the pH and convert the entrained iron into dissolved iron phosphate. The pH of the solution bearing the iron phosphate solute is then increased by the addition of a base, elevating the pH to a level at which the iron phosphate is insoluble and affording precipitation. The precipitate and high pH brine are separated and the brine buffered to a suitable pH as needed by process. Some of the advantages of the present invention over the prior art include:

(a) The removal of iron is unimpeded by the presence of oils or hydrocarbons, conveying a distinct advantage over the prior art; auspiciously pertaining to iron removal from oil and gas production brines. In this application, the invention proffers the elimination of expensive and troublesome pretreatment equipment for removal of oils and hydrocarbons.

(b) The invention employs a chemical-based process eliminating specific appliance or hardware limitations. Since the invention is useful in the treatment of very corrosive oil and gas production brines, limitations and disadvantages associated with exotic materials of construction necessary for appliances of the prior art are not required.

(c) In certain embodiments, the invention employs simple and inexpensive chemicals rather than one or more of the ion exchange medias common to the prior art, wherein such medias are burdened by sensitivity to blinding, fouling and/or poisoning by extraneous salts, metals and other common contaminants entrained in the iron bearing solutions. This is particularly problematic with oil and gas production brines. Media life is exceptionally short when treating these brines. Accordingly, the invention purveys a substantially more reliable, longer life, more efficient course for removal of entrained iron than the media based technologies of the prior art. Further, the invention does not generate the disposal expense and associated environmental liabilities which encumbrance the media based technologies of the prior art.

(d) In certain embodiments, the invention does not require additional chemicals to refurbish media as is a common practice of the prior art. Accordingly, certain embodiments of the invention eliminate the expense, storage and handling associated with said washing and regeneration chemicals. Further, additional chemicals are not required, the expense and environmental liabilities associated with disposal of spent volumes of these chemicals is eliminated.

(e) Variations in water constituents can dramatically and negatively affect the performance of many examples of the prior art. Such changes are especially common with oil and gas production brines. In contrast to the sensitivity that the prior art often demonstrates with such changes, the invention is robust in accommodating these changes.

The making and using of the embodiments illustrated herein are discussed in detail below. It should be appreciated, however, that the present invention provides many applicable inventive concepts that can be embodied in a wide variety of specific contexts. The specific embodiments discussed herein are merely illustrative of specific ways to make and use the invention, and do not limit the scope of the invention. The present invention will be described with respect to the subject embodiments in a specific context, namely as a device and process for reduction iron in aqueous or brine based solutions. The invention may also be applied, however, to other situations wherein similar iron reduction effects are desirable.

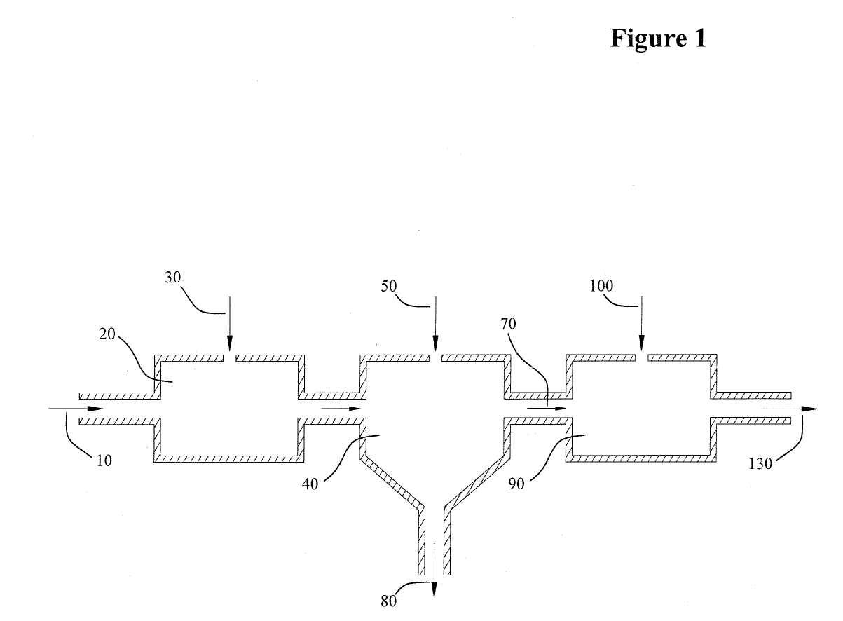

One embodiment of the present invention is illustrated in FIG. 1, wherein iron entrained aqueous solution (brine) 10 is conveyed into an acidic reaction vessel 20 wherein a phosphoric acid solution 30 is added to reduce the pH of the brine. The low pH brine conveys from the acidic reaction vessel 20 into the base reaction vessel 40 wherein a base chemical 50 is added to elevate the pH. Iron phosphate 80 precipitates from the solution in reaction vessel 40 and exits the reaction vessel 40. The reduced iron supernatant 70 separates from the precipitate and exits the reaction vessel 40 in conveyance to the buffering vessel 90. Acidic chemical 100 is added in the buffering reaction vessel 90 to lower the pH to a suitable level and the reduced iron precipitant 130 is conveyed to process.

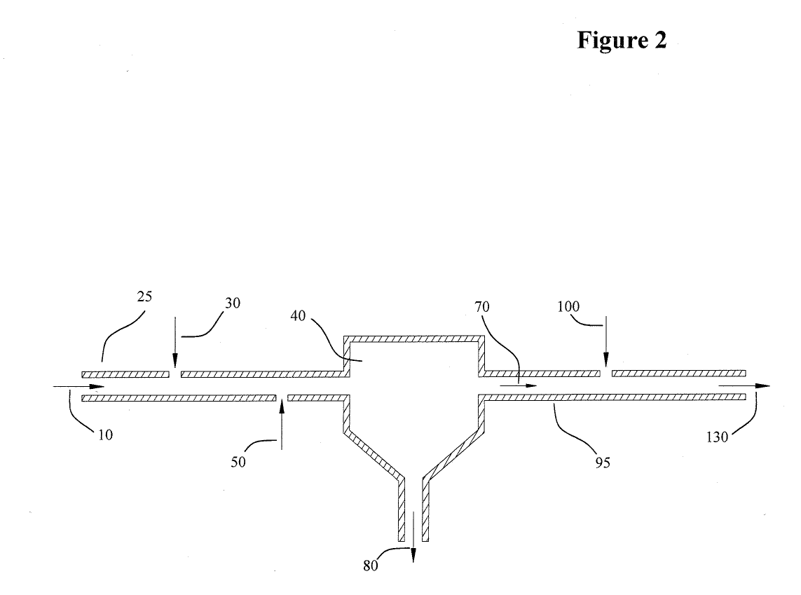

Another embodiment of the present invention is illustrated in FIG. 2, wherein iron entrained aqueous solution (brine) 10 is conveyed into a pipeline 25 wherein, while in transit, a phosphoric acid solution 30 is added to reduce the pH of the brine. Further in transit a base chemical 50 is added to elevate the pH. The elevated pH brine then enters a base reaction vessel 40 providing quiescence necessary for settling of precipitating iron phosphate. The reduced iron supernatant 70 separates from the precipitate and exits the base reaction vessel 40. Iron phosphate 80 separates from the elevated pH brine and exits from the reaction vessel 40. Reduced iron supernatant 70 conveys via pipeline 95 from the reaction vessel 40. Acidic chemical 100 is added into the pipeline 95 to lower the pH of the reduced iron brine to create a reduced iron precipitate 130 suitable with suitable pH for conveyance to process.

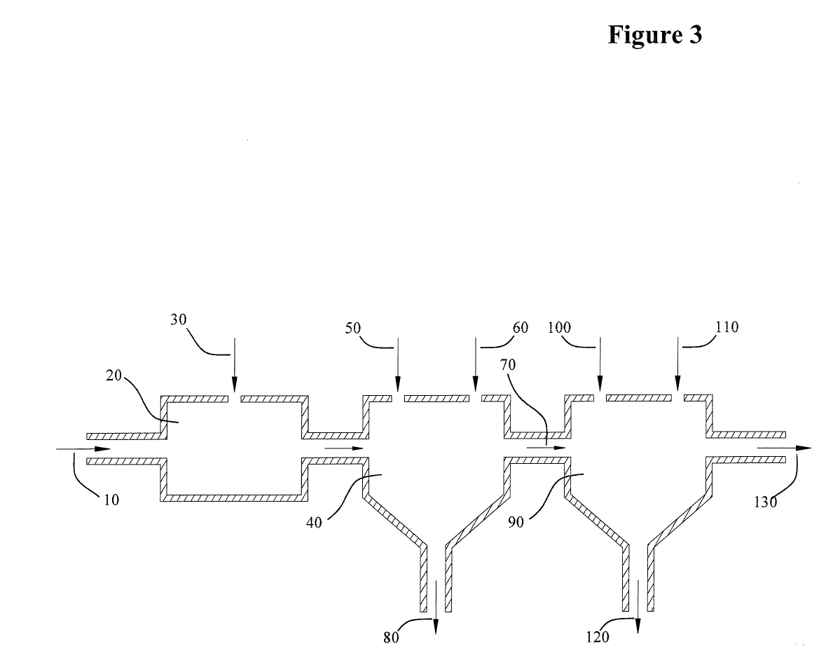

Another embodiment of the present invention is illustrated in FIG. 3, wherein iron entrained aqueous solution (brine) 10 is conveyed into a reaction vessel 20 wherein a phosphoric acid solution 30 is added to reduce the pH of the brine. The lowered pH brine is then conveyed into a second reaction vessel 40 wherein a base chemical 50 is added to raise the pH to afford precipitation of iron phosphate from the brine solution. An additional flocculating chemical 60 is added into the precipitating brine solution in reaction vessel 40 to accelerate and enhance the precipitate settling and separation effects. The settled iron phosphate 80 exits the reaction vessel 40. The reduced iron supernatant 70 separates from the precipitate and exits the reaction vessel 40 and conveys into buffering vessel 90 wherein an acidic chemical 100 is added to lower the pH of the reduced iron brine to a suitable pH for process use. As a consequence of the reduction of the pH, additional precipitate may form for which the buffering vessel 90 provides quiescence for settling and separation. An additional flocculating chemical 110 is added into buffering vessel 90 to accelerate and enhance the precipitate settling and separation effects. The settled precipitate 120 exits the reaction vessel 90. The reduced iron precipitate 130 exits the reaction vessel 90 to process.

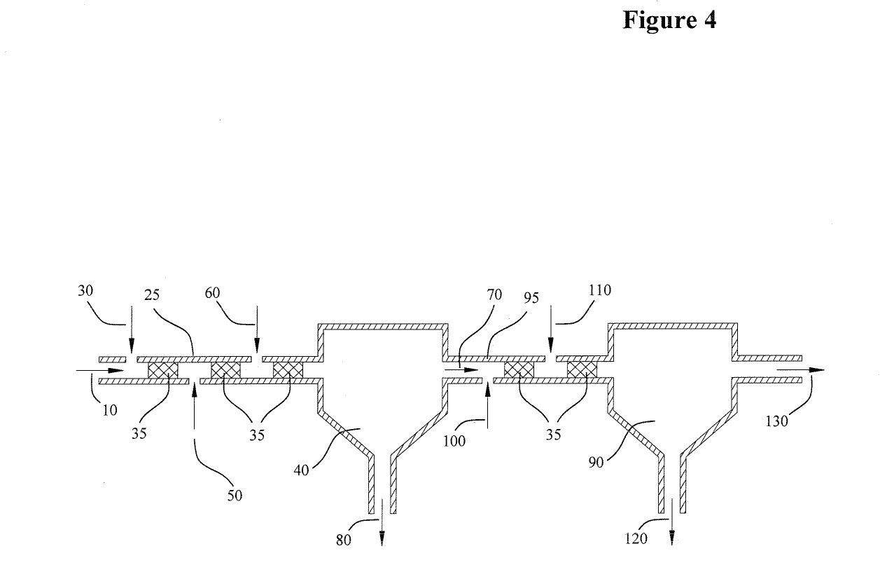

Another embodiment of the present invention is illustrated in FIG. 4, wherein iron entrained aqueous solution (brine) 10 is conveyed into a pipeline 25 wherein, while in transit, a phosphoric acid solution 30 is added to reduce the pH of the brine. A mixing appliance 35, such as a static pipeline mixer, is provided downstream of the addition of the phosphoric acid solution 30 to enhance mixing of the phosphoric acid into the brine solution. Further in transit down the pipeline 25, a base chemical 50 is added to the flowing brine to elevate the pH. A mixing appliance 35, such as a static pipeline mixer, is provided downstream of the addition of the base chemical 50 to enhance mixing and elevation of the flowing brine pH in the pipeline 25. As a consequence of the elevated pH, iron phosphate precipitate forms in the flowing brine. Further in transit down the pipeline 25 a flocculating chemical 60 is added to the flowing brine to enhance the precipitation of iron phosphate. A mixing appliance 35, such as a static pipeline mixer, is provided downstream of the addition of the flocculating chemical 60 to enhance mixing and contacting between precipitates and the flocculating chemical 60. The elevated pH brine with entrained flocculating precipitates enters a reaction vessel 40 providing quiescence necessary for settling of precipitating iron phosphate. The reduced iron supernatant 70 separates from the precipitate and exits the reaction vessel 40. Iron phosphate 80 precipitate from the elevated pH brine and exits from the reaction vessel 40. Reduced iron supernatant 70 with high pH conveys via pipeline 95 from the reaction vessel 40. Acidic chemical 100 is added into the pipeline 95 to lower the pH of the reduced iron brine to a suitable pH for eventual process use. A mixing appliance 35, such as a static pipeline mixer, is provided downstream of the addition of the acidic chemical 100 to enhance homogeneous pH reduction. As a consequence of the lowered pH, various precipitates can form in the flowing brine. Further in transit down the pipeline 95, an additional flocculating chemical 110 is added to the flowing brine to enhance the aggregation of precipitates. A mixing appliance 35, such as a static pipeline mixer, is provided downstream of the addition of the additional flocculating chemical 110 to enhance mixing and contacting between precipitates and the flocculating chemical. The buffered pH brine with entrained flocculating precipitates enters a buffering vessel 90 providing quiescence necessary for settling of precipitates. The buffered, reduced iron supernatant 130 separates from the precipitate and exits from the buffering vessel 90. Settled precipitates 120 separate from the buffered pH brine and exit from the buffering vessel 90. The reduced iron precipitate 130 exits the reaction vessel 90 to process.

Those skilled in the art recognize that the invention provides a means to efficiently and robustly remove both ferrous (Fe⁺⁺) iron and ferric (Fe⁺⁺⁺) iron from an aqueous solution (brine). The advantages over the prior art are substantial and include, among many others:
Oils and entrained hydrocarbons or grease do not hinder the process; thereby eliminating pretreatment requirements and associated capital, operating and labor expenses.
Certain embodiments of the invention employ chemicals which minimize the requirement for hardware, appliances and other components prone to damage from the corrosive effects of oil and gas production brines.
Certain embodiments of the invention employ fluid based chemical reactions; not requiring ion exchange or other type of contacting media. Without the employ of such media the blinding, poisoning and fouling problems associated with the media techniques of the prior art are eliminated.
Certain embodiments of the invention eliminate the use of the media common to the prior art, thereby eliminating the environmental expense and liabilities associated with disposal of spent media.
Certain embodiments of the invention do not employ media requiring chemical regeneration.
Certain embodiments of the invention employ chemicals wherein the dosage is controlled by pH. Such control affords the flexibility of successful iron removal regardless of the customary variations of brine constituents which afflicts oil and gas production brines.

While the foregoing discussions specify the many advantages inherent to the invention these do not constitute the full scope of the inventions advantages. There are many advantages beyond those defined herein. In a similar manner, the embodiments described in the foregoing are not the only embodiments possible. Other embodiments are possible.

Embodiments wherein various combinations of sections of the foregoing embodiments are certainly conceivable. Also, in certain embodiments beneficial appliances may be employed. Example of such would be the employ of centrifugal separation devices such as centrifuges or hydrocyclones to accelerate precipitate removal. Filtration devices could also be so used.

In certain embodiments thermal processes could be also employed. An example would be heating of reaction vessels to expedite pH and mixing reactions. Another possibility would be heating or cooling to expedite the precipitate separation.

In certain other embodiments electrical coagulation appliances could also be used to accelerate the precipitate agglomeration and separation. Mixing paddles in the reaction and buffering vessels could also be employed to further homogenize the chemical mixtures to assure rapid and complete chemical reactions.

Those skilled in the art will appreciate that many other additional refinements employing existing art to enhance the performance of the invention; especially in those situations of which one skilled in the art may be especially familiar.

What is claimed is:

1. A chemical device for reduction of iron in aqueous solution comprising:
a containment vessel confining an iron entrained aqueous solution;
a conveyance for adding phosphoric acid to said aqueous solution; and
a conveyance for adding a base chemical to said aqueous solution,
wherein addition of said phosphoric acid and said base chemical results in separation of entrained iron from said aqueous solution.

2. The device of claim 1, wherein the phosphoric acid is added first to drop the pH of said iron entrained aqueous solution.

3. The device of claim 1, wherein the phosphoric acid is added first and sufficiently to drop the pH of said iron entrained aqueous solution to 4 or less.

4. The device of claim 1, wherein said base chemical is added after said phosphoric acid addition to increase the pH of the iron entrained aqueous solution.

5. The device of claim 1, wherein the base chemical is added, after said phosphoric acid addition, sufficiently to increase the pH of said phosphoric acid dosed, iron entrained aqueous solution to 8.5 or more.

6. The device of claim 1, wherein said base chemical is sodium hydroxide.

7. The device of claim 1, including additional conveyances for adding one or more chemicals, wherein said chemicals agglomerate and enhance separation of iron compounds precipitating from the aqueous solution.

8. The device of claim 7 wherein said chemicals are anionic charged polymer flocculants.

9. The device of claim 1, including additional conveyances for adding one or more chemicals, sequentially, after the addition of said phosphoric acid and said base chemical, wherein said chemicals agglomerate and enhance separation of iron compounds precipitating from said aqueous solution.

10. A chemical device for reduction of iron in aqueous solution comprising:
a containment vessel confining an iron entrained aqueous solution;
a conveyance for adding phosphoric acid to the iron entrained aqueous solution;
a conveyance for adding a base chemical to the iron entrained aqueous solution;
an inlet liquid conveyance to the confinement vessel;
an outlet liquid conveyance from the confinement vessel; and
a solids outlet conveyance from the confinement vessel,
wherein said iron entrained aqueous solution is proffered via said liquid inlet conveyance into said confinement vessel, wherein said phosphoric acid and said base chemical are conveyed, respectively, into said aqueous solution, resulting in precipitation and separation of iron compounds, whereof said solids outlet conveyance purveys discharge from said confinement vessel as a separate and isolated product from said reduced iron aqueous solution product further conveyed from said confinement vessel via said liquid outlet conveyance.

11. The device of claim 8, wherein said phosphoric acid is added first to drop the pH of the iron entrained aqueous solution.

12. The device of claim 8, wherein said phosphoric acid is added first and sufficiently to drop the pH of said iron entrained aqueous solution to 4 or less.

13. The device of claim 8, wherein said base chemical is added after said phosphoric acid addition to increase the pH of said iron entrained aqueous solution.

14. The device of claim 8, wherein said base chemical is added, after said phosphoric acid addition, sufficiently to increase the pH of said phosphoric acid ringed, iron entrained aqueous solution to 8.5 or more.

15. The device of claim 8, wherein said base chemical is sodium hydroxide.

16. The device of claim 8, including additional conveyances for adding one or more chemicals, wherein said chemicals agglomerate and enhance separation of iron compounds precipitating from said aqueous solution.

17. The device of claim 16, wherein said chemicals are anionic charged polymer flocculants.

18. The device of claim 8, including an additional conveyances for adding one or more chemicals, sequentially, after the addition of said phosphoric acid and said base chemical, wherein said chemicals agglomerate and enhance separation of iron compounds precipitating from the aqueous solution.

19. The device of claim 8, wherein said phosphoric acid conveyance purveys said phosphoric acid into said liquid inlet conveyance, prior to issuance into said confinement vessel.

20. The device of claim 8, wherein said phosphoric acid conveyance purveys said phosphoric acid into said liquid inlet conveyance, wherein a mixing appliance is further provided.

21. The device of claim 8, wherein said phosphoric acid conveyance and said base chemical conveyance purveys said phosphoric acid and said base chemical into said liquid inlet conveyance, prior to issuance into said confinement vessel.

22. The device of claim 8, wherein said phosphoric acid conveyance and said base chemical conveyance purveys said phosphoric acid and said base chemical into said liquid inlet conveyance, wherein mixing appliances are further provided.

23. The device of claim 8, wherein said phosphoric acid conveyance and said base chemical conveyance and further agglomerating chemical conveyances purveys said phosphoric acid and said base chemical as well as precipitate agglomerating chemicals into said liquid inlet conveyance, prior to issuance into said confinement vessel.

24. The device of claim 8, wherein said phosphoric acid conveyance and said base chemical conveyance and further agglomerating chemical conveyances purveys said phosphoric acid and said base chemical as well as precipitate agglomerating chemicals into said liquid inlet conveyance, wherein mixing appliances are further provided.

25. The device of claim 8, wherein said liquid inlet conveyance includes provision of a reaction vessel for receiving said phosphoric acid conveyance.

26. A chemical device for reduction of iron in aqueous solution comprising:
a containment vessel confining an iron entrained aqueous solution;
a conveyance for adding phosphoric acid to the iron entrained aqueous solution;
a conveyance for adding a base chemical to the iron entrained aqueous solution;
an inlet liquid conveyance to the confinement vessel;
an outlet liquid conveyance from the confinement vessel;
a solids outlet conveyance from the confinement vessel;
a buffering vessel;
a final liquid conveyance from the buffering vessel; and
a conveyance to add an acidic solution,
wherein said iron entrained aqueous solution is proffered via said liquid inlet conveyance into said confinement vessel, wherein said phosphoric acid and said base chemical are conveyed, respectively, into said aqueous solution, resulting in precipitation and separation of iron compounds, whereof said solids outlet conveyance purveys discharge from said confinement vessel as a separate and isolated product from the reduced iron aqueous solution product further conveyed from said confinement vessel via said liquid outlet conveyance into said buffering vessel, said reduced iron aqueous product being pH adjusted by said acidic solution conveyance, wherein suitably buffered, reduced iron aqueous solution product is discharged from said buffering vessel to process via said final liquid outlet conveyance.

27. The device of claim 26, wherein said phosphoric acid is added first to drop the pH of said iron entrained aqueous solution.

28. The device of claim 26, wherein said phosphoric acid is added first and sufficiently to drop said pH of the iron entrained aqueous solution to 4 or less.

29. The device of claim 26, wherein said base chemical is added after said phosphoric acid addition to increase said pH of the iron entrained aqueous solution.

30. The device of claim 26, wherein said base chemical is added, after said phosphoric acid addition, sufficiently to increase said pH of the phosphoric acid dosed, imp entrained aqueous solution to 8.5 or more.

31. The device of claim 26, wherein said base chemical is sodium hydroxide.

32. The device of claim 26, including additional conveyances for adding one or more chemicals, wherein said chemicals agglomerate and enhance separation of iron compounds precipitating from said aqueous solution.

33. The device of claim 32, wherein said chemicals are anionic charged polymer flocculants.

34. The device of claim 26, including an additional conveyances for adding one or more chemicals, sequentially, after the addition of said phosphoric acid and said base chemical, wherein said chemicals agglomerate and enhance separation of iron compounds precipitating from said aqueous solution.

35. The device of claim 26, wherein said phosphoric acid conveyance purveys said phosphoric acid into said liquid inlet conveyance, prior to issuance into said confinement vessel.

36. The device of claim 26, wherein said phosphoric acid conveyance purveys said phosphoric acid into said liquid inlet conveyance, wherein a mixing appliance is further provided.

37. The device of claim 26, wherein said phosphoric acid conveyance and said base chemical conveyance purveys said phosphoric acid and said base chemical into said liquid inlet conveyance, prior to issuance into said confinement vessel.

38. The device of claim 26, wherein said phosphoric acid conveyance and said base chemical conveyance purveys said phosphoric acid and said base chemical into said liquid inlet conveyance, wherein mixing appliances are further provided.

39. The device of claim 26, wherein said phosphoric acid conveyance and said base chemical conveyance and further agglomerating chemical conveyances purveys said phosphoric acid and said base chemical as well as precipitate agglomerating chemicals into said liquid inlet conveyance, prior to issuance into said confinement vessel.

40. The device of claim 26, wherein said phosphoric acid conveyance and said base chemical conveyance and further agglomerating chemical conveyances purveys said phosphoric acid and said base chemical as well as precipitate agglomerating chemicals into said liquid inlet conveyance, wherein mixing appliances are further provided.

41. The device of claim 26, wherein said liquid inlet conveyance includes provision of a reaction vessel for receiving said phosphoric acid conveyance.

42. The device of claim 26, wherein a buffering product solids outlet conveyance proffers precipitate and agglomerated solids removal from said buffering vessel.

43. The device of claim 26, wherein a buffering product solids outlet conveyance proffers precipitate and agglomerated solids removal from said buffering vessel.

44. The device of claim 26, wherein said conveyance for an acidic solution purveys phosphoric acid.

45. The device of claim 26, including additional conveyances for adding one or more chemicals, wherein said chemicals agglomerate and enhance separation of precipitates which form as a buffering product.

46. The device of claim 45, wherein said chemicals are anionic polymer flocculants.

47. The device of claim 26, wherein said acidic solution conveyance purveys into said confinement vessel liquid outlet conveyance prior to entry into said buffering vessel.

48. The device of claim 26, wherein said acidic solution conveyance purveys into said confinement vessel liquid outlet conveyance prior to entry into said buffering vessel, wherein a mixing appliance is further provided.

49. The device of claim 26, including additional conveyances for adding one or more chemicals, wherein said chemicals agglomerate and enhance separation of precipitates which form as a buffering product, wherein said chemical conveyance proffers into said confinement vessel liquid outlet conveyance prior to said buffering vessel.

50. The device of claim 26, including additional conveyances for adding one or more chemicals, wherein said chemicals agglomerate and enhance separation of precipitates which form as a buffering product, wherein said chemical conveyance proffers into said confinement vessel liquid outlet conveyance prior to said buffering vessel, wherein a mixing appliance is further provided.
